(19) United States
(12) Patent Application Publication
(10) Pub. No.: US 2003/0180213 A1
(43) Pub. Date: Sep. 25, 2003

(54) High surface area mixed metal oxides and hydroxides

(76) Inventors: Corrie L. Carnes, Manhattan, KS (US); Gavin Mark Medine, Manhattan, KS (US); Kenneth J. Klabunde, Manhattan, KS (US)

Correspondence Address: HOVEY WILLIAMS LLP, Suite 400, 2405 Grand, Kansas City, MO, 64108, US

(21) Appl. No.: 10/074,932

(22) Filed: Feb. 11, 2002

(51) Int. Cl. C01F 7/30

(52) U.S. Cl. 423/592.1; 423/628

(57) ABSTRACT

Multiple-component solid compositions including at least two intermingled, different solid oxides or hydroxides are provided which have extremely small crystallite sizes (at least one of the materials exhibits a crystallite size of about zero to 4 nm) and large surface areas. The compositions comprise at least two molecularly intermingled nanocrystalline materials selected from the group consisting of the oxides and hydroxides of the elements of Groups IIA, IIIA, IVA, the transition metals and the lanthanide series of the Periodic Table. The compositions are synthesized by separately preparing alkoxide solutions which are then mixed and hydrolyzed to give a gel; the gel is then treated to yield the desired hydroxide or oxide final composition. The compositions are useful for sorption of target materials such as undesireable compounds or biological materials. Extremely high surface area aluminum oxides having BET surface areas of at least about 700 m²/g are also disclosed.

### FEDERALLY SPONSORED RESEARCH/DEVELOPMENT PROGRAM

This invention was made with government support under Grant DAAD19-99-1-0228 awarded by the United States Army Research Office. The government has certain rights in the invention.

### BACKGROUND OF THE INVENTION

1. Field of the Invention

The present invention is directed to multiple-component, highly reactive nanocrystalline compositions including at least two nanocrystalline materials selected from the oxides and hydroxides of the elements of Groups IIA, IIIA, IVA, the transition metals and the lanthanide series of the Periodic Table, wherein the materials are solidified and intimately intermingled on a molecular level. Such compositions exhibit very small average crystallite sizes and correspondingly large surface areas. A synthesis for such compositions also forms a part of the invention, along with methods of use thereof. Nanocrystalline aluminum oxides having BET surface areas of at least about 700 m²/g are also disclosed..

2. Description of the Prior Art

Considerable work has been done in the past in connection with the synthesis and use of various nanocrystalline (NC) metal oxides such as aluminum and magnesium oxides. Such materials have very high surface areas and some have been shown to be excellent adsorbents for a variety of target substances such as chlorinated hydrocarbons. NC metal oxides are often much more reactive than their conventionally or commercially made (CM) metal oxide counterparts. Nanocrystalline oxides have been prepared as single oxides or as composites with a core oxide and a coating of a second, different oxide. See, e.g., U.S. Pat. Nos. 6,087,294, 6,057,488, 5,712,219, 6,045,925, 5,914,436, 5,759,939 and 5,712,219.

Mixed metal oxides also play an appreciable role in many areas of chemistry and physics. The unique electronic and magnetic properties obtained when combining two metals in an oxide matrix have been well studied. However, the most common use for mixed metal oxides has been in the area of catalysis, and here they have found use both as the catalyst and as the support. Specifically, mixed metal oxides containing aluminum have found catalysis uses, such as:

Destructive oxidation of methyl sulfide (CuO/Al₂O₃)

Denitrogenation of heteroaromatic compounds (Mo/Al₂O₃—SiO₂)

Isomerization of olefins, paraffins, and alkyl aromatics (Al₂O₃/SiO₂)

Ammoxidation of 3-picoline (V₂O₅/Al₂O₃—SiO₂)

Dimerization and oligomerization of olefins (NiO/Al₂O₃—SiO₂)

Combustion of methane (Pd/Al₂O₃—SiO₂)

The mixed MgO/Al₂O₃ system has been studied by several research groups for many applications, including catalysis. In 1996 Abello, et al. studied Mo supported on MgO/Al₂O₃ for the oxidative dehydration of propane. Preparation of the catalyst was conducted by impregnating alumina with a solution of Mg(NO₃)₂. The samples were then dried, and calcined at 723K for 2 hours. The authors reported surface areas of 136-184 m²/g depending on the % MgO. The catalyst was then added by impregnating the support in an ammonium hexamolybdate solution, and calcined again. The final catalyst was found to be very active and stable toward the oxidative dehydrogenation of propane, but was found to lose selectivity due to the formation of carbon oxides. More recently Chi, et al. published results of nitrates being adsorbed onto MgO/Al₂O₃. These results demonstrated that MgO/Al₂O₃ adsorbed more NO at 523K than did Tb₄O₇/Al₂O₃, La₂O₃/Al₂O₃, or BaO/Al₂O_{3.}

Whether alone or as a part of a mixed metal oxide, alumina or aluminum oxide (Al₂O₃) is probably the most important metal oxide, both for catalysis and in other applications such as an absorbent for organic molecules and as a wear-resistant coating. Because alumina has so many uses, there are a number of preparative methods available. Recently, significant interest has been expressed in NC alumina and the size-dependent properties thereof. Several researchers have undertaken projects to find improvements in alumina strength, catalytic activity and ductility, based upon decreasing the crystallite size.

In 1991 Chou, et al. published data on preparing nanocrystalline alumina via reactive sputtering deposition. Using this technique γ aluminum oxide films were deposited from a hot pressed Al₂O₃ target by r.f. magnetron reactive sputter deposition in a plasma of argon and oxygen. These films were deposited onto silicon and NaCl substrates, and were found to have an average grain (crystallite) size of 10 nm, and after annealing at 800° C. for 2 hours this remained constant. However, the grain size grew upon heating at 800° C. for 24 hours, 1000° C. for 2 hours, and 1200° C. for 2 hours to 13 nn, 15 mn, and 50 nm respectively. This report yielded good insight into the micromechanical properties of nanocrystalline films. Later, Dockale, et al. reported on the enhanced surface reactivity of nanocrystalline alumina. In their work the nanocrystalline alumina was synthesized by gas phase condensation using a DC arc plasma technique. This technique produced 20-80 nm spherical polymorphous aluminum particles, which was highly crystalline according to XRD patterns. Also discussed was the enhanced surface activity of the alumina. An interesting method of preparation utilizing crysol techniques was reported by Mamchik, et al. An aluminum nitrate solution (in water) was first prepared and then sent through ion exchange using a polymeric base anion exchange resin to convert the Al(NO₃)₃ to Al(OH)₃. Next the colloid was frozen and freeze dried to leave dry Al(OH)₃. Lastly a step of thermal dehydration was used to convert the hydroxide to oxide. Although these authors discussed an interesting method of preparation, the characterization data, although showing that the sample was made up of amorphous γ and α alumina, was focused on ²⁷Al NMR.

In 1999 Patra, et al. published a preparation for alumina nanoparticles to be used for catalyst supports. In this work alumina was prepared by the hydrolysis of alumina sec-butoxide in 1-octanol, 1-butanol, and acetonitrile. In this method a dispersant (hydroxy propylcellulose) was used. The resulting alumina consisted of 200 nm particles, the crystal phase unknown. Later that same year Wang, et al. reported preparing nanocrystalline alumina by sol-gel methods. The crystallite size of the γ-Al₂O₃ was found after annealing at 400° C., 600° C., and 800° C. to be 5.5 nm, 7.9 nm, and 9.7 nm respectively. More recently Ramesh, et al. studied the preparation of nanocrystalline γ-Al₂O₃ by hydrolysis of aluminum triisopropoxide, under ultrasound and in the presence of a peptizer. The dried samples were calcined at 700° C. The XRD patterns confirm that the samples were amorphous, and surface area before calcining were 83-143 m²/g, and after calcining 97-183 m²/g.

Despite the magnitude of prior efforts to produce small crystallite/high surface area alumina, a practical limit of 450-550 m²/g BET surface area has never been exceeded. Given the commercial importance of alumina, a method for producing NC Al₂O₃ having significantly higher surface areas would be a signal development. By the same token, new NC mixed metal oxides and hydroxides likewise having small crystallite size/high surface areas and enhanced surface chemistries would be highly desirable.

### SUMMARY OF THE INVENTION

The present invention in one aspect is directed to the provision of particulate compositions comprising at least two nanocrystalline materials selected from the group consisting of the oxides and hydroxides of the elements of Groups IIA, IIIA, IVA, the transition metals and the lanthanide series of the Periodic Table, where at least one of the materials exhibits an average crystallite size of about 4 nm or less by XRD analysis. As used herein, reference to an average crystallite size of about 4 nm or less embraces situations where, by XRD analysis, the analysis indicates no crystallite size whatsoever, or alternately a small crystallite size up to about 4 nm, i.e., the average crystallite size ranges from about zero to up to about 4 nm. Such compositions also normally have a BET surface area which is at least about 30%, and more preferably at least about 50%, greater than the corresponding surface area of at least one of the individual nanocrystalline materials, and more preferably each of such individual nanocrystalline materials, if the respective NC materials were prepared alone using the same conditions as the mixed compositions of the invention.

In preferred forms, the compositions are made up of from 2-4 different oxides or hydroxides, and most preferably are binary systems containing two different materials; moreover, all of the different materials of the composition should advantageously have an average crystallite size of from about zero up to about 4 nm or by XRD analysis. The preferred class of different materials are selected from the group consisting of the oxides and hydroxides of Al, Mg, Ca, Sr, Ba, Zn, Co, Ni, Fe, Ti, Pd, Rh, V, Mn, Ga and Si. In the case of binary compositions the following combinations are especially desirable: Al₂O₃.MgO, Al₂O₃.CaO, Al₂O₃.SrO, Al₂O₃.BaO, Al₂O₃.ZnO, Al₂O₃.CoO, Al₂O₃.NiO, Al₂O₃.Fe₂O₃, Al₂O₃.MgO.TiO₂, Al₂O₃.PdO, Al₂O₃.RhO, Al₂O₃.V₂O₃, Al₂O₃.MnO, Ga₂O₃.MgO, and SiO₂.MgO. A particularly preferred binary composition contains aluminum oxide and magnesium oxide. Generally, one of the materials is present in a greater amount by weight as compared with another of the materials, so that the greater amount material can be deemed a matrix, with the lesser amount material being dispersed within the matrix. In terms of molar ratios, binary compositions in accordance with the invention should have a molar ratio of the first to the second material ranging from about 0.1-10.

The nanocrystalline compositions of the invention, made up of a plurality of nanocrystalline hydroxides or oxides, are fundamentally different than mere mixtures of two or more individually prepared hydroxides or oxides. That is, owing to the synthesis technique wherein the corresponding alkoxides are simultaneously co-solidified, the hydroxides or oxides of the final compositions are intimately intermingled on a molecular level. These compositions are not necessarily homogeneous, but in all cases the respective hydroxides or oxides making up the compositions are distributed on a molecular basis throughout the solidified compositions.

A method of preparing particulate, multiple nanocrystalline compositions comprises the steps of first separately preparing a plurality of different alkoxide solutions in respective compatible solvents, with each alkoxide including an ion moiety selected from the group consisting of the ions of the elements of Groups IIA, IIIA, IVA, the transition metals and the lanthanide series of the Periodic Table. These separate alkoxide solutions are mixed and hydrolyzed to yield an aqueous gel comprising the corresponding solidified hydroxides of the different alkoxides. Thereafter, the hydroxide gel is either dried to yield particulate hydroxide compositions or thermally converted to give the corresponding particulate oxide compositions.

Generally, each of the different alkoxides has the formula [R—O]ₙ—X_{q}, where R is a C1-C6 straight or branched chain alkyl group, X is an ion moiety as previously described, and n and q are selected so as to balance the valence of the alkoxide; particularly preferred alkoxides of this formula are those where R is a tert-butyl group.

In carrying out the synthesis of the mixed compositions to give oxide compositions, the thermal conversion step should be carried out at a temperature of from about 300-600° C. for a period of from about 15-200 minutes. Of course, these conditions are variable, depending upon the nature of the selected starting materials. In the case of hydroxide compositions, the drying of the hydroxide gel is preferably carried out at a temperature of from about 25-300° C. for a period of from about 15-200 minutes.

The mixed compositions of the invention are particularly useful for the sorption of target materials through adsorption or chemisorption. This involves contacting a selected composition with a target material under appropriate conditions. An almost limitless number of target materials are subject to such treatment, such as those selected from the group consisting of compounds selected from the group of acids (e.g., H₂S and SO₂), alcohols (e.g., C1-C10 straight and branched chain organic alcohols), aldehydes, compounds containing an atom of P, S, N, Se, or Te, hydrocarbon compounds (e.g., halogenated hydrocarbons), toxic metal compounds, halogenated compounds, bacteria, fungi, viruses, rickettsiae, chlamydia, and toxins. One way of effecting contact between the compositions and target materials is contacting a fluid containing a target material with a quantity of the composition. The fluid may be a liquid or a gas (e.g., natural gas containing H₂S). Another method involves distributing a quantity of the composition onto an area where a target material is present, such as in environmental decontamination. The contacting can be carried out over a wide range of temperatures, typically from about−70-800° C., and more preferably from about−25-100° C.

The gel intermediates involved in the preferred synthesis of the composites are also apart of the invention, which as described can be dried to yield the hydroxides or converted to give the oxides.

In another aspect of the invention, nanocrystalline aluminum oxide is provided having extraordinarily high BET surface areas of at least about 700 m²/g and more preferably from about 725-850 m²/g. Such aluminas normally exhibit a completely amorphous pattern by XRD analysis. such aluminas can be used in the same fashion as the multiple-component compositions described above, i.e., the same classes of target materials, contacting techniques and temperatures are applicable.

### BRIEF DESCRIPTION OF THE DRAWINGS

FIG. 1 is a bar graph depicting the surface area results for nanocrystalline (NC—Al₂O₃) aluminum oxide produced in accordance with the present invention, after dynamic vacuum activation or argon flow activation;

FIG. 2 is a graph of the surface areas of CM—Al₂O₃ and NC—Al₂O₃ upon heat treatment;

FIG. 4 is a chart of XRD patterns for CM—Al₂O₃ and NC—Al₂O₃;

FIG. 3 is a graph of the surface area versus applied pressure on NC—Al₂O₃ (PL=pounds load);

FIG. 5 is a chart of XRD patterns of NC—Al₂O₃ after heating at 25° , 200° C., 400° C., 500° C., and 700° C.;

FIG. 6a is a transmission electron microscope (TEM) photograph of CM—Al₂O₃

FIG. 6b is a TEM photograph of NC—Al₂O₃;

FIG. 7 is an high resolution TEM photograph of NC—Al₂O₃;

FIG. 8 a bar graph depicting the surface area results for aluminum/magnesium oxide after dynamic vacuum activation or argon flow activation;

FIG. 9 is a graph of surface areas of CM—Al₂O₃, CM—MgO and NC-(1/1) Al₂O₃/MgO upon heat treatment;

FIG. 10 is a graph of surface area vs. applied pressure on NC-(1/1) Al₂O₃/MgO;

FIG. 11 is a chart of XRD patterns for CM—Al₂O₃, CM—MgO and NC-(1/1) Al₂O₃/MgO;

FIG. 12 is a chart of XRD patterns of NC-(1/1) Al₂O₃/MgO after heat treating at 25° , 100° C., 300° C., 500° C., and 700° C.;

FIG. 13a is a TEM photograph of CM—MgO;

FIG. 13b is a TEM photograph of NC—Al₂O₃/MgO;

FIG. 14 is a graph illustrating the results of CCl₄ comparative destruction tests using CM—Al₂O₃and NC—Al₂O₃;

FIG. 15 is a graph illustrating the results of CCl₄ comparative destruction tests using CM—Al₂O₃, CM—MgO, and NC-(1/1) Al₂O₃/MgO;

FIG. 16 is a schematic illustration of the IR cell used in SO₂ adsorption experiments in accordance with the invention;

FIG. 17 is a graph illustrating IR spectra after 2 hour evacuation at room temperature, for CM—Al₂O₃, NC—Al₂O₃, CM—MgO and NC—Al₂O₃MgO;

FIG. 18 is a graph illustrating the results of a paraoxon sorption test using CM—Al₂O₃ and NC—Al₂O₃, showing paraoxon absorbance band versus time;

FIG. 19 is a graph illustrating the results of a paraoxon sorption test using CM—MgO, Al₂O₃/MgO and a blank, showing paraoxon absorbance band versus time; and

FIG. 20 is a graph illustrating IR spectra for CM—Al₂O₃, and NC—Al₂O₃, CM—MgO, and NC—Al₂O₃/MgO taken after reaction with paraoxon.

### DETAILED DESCRIPTION OF THE PREFERRED EMBODIMENT

The following examples set forth preferred compositions and methods in accordance with the invention. It is to be understood, however, that these examples are provided by way of illustration and nothing therein should be taken as a limitation upon the overall scope of the invention.

Preparation of Nanocrystalline (NC) Al₂O₃

In this example, pure nanocrystalline Al₂O₃ powder was synthesized and isolated. The reactions involved in the preparation are shown below.

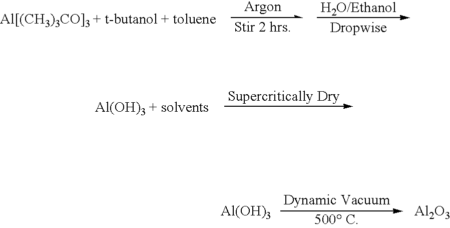

The synthesis consisted of three main steps:

1. Synthesis of the Aluminum Hydroxide Powder.

The chemicals used in the synthesis were directly from a commercial source without further purification. Under argon 1.00 g (0.0040 mole) aluminum tri-tert-butoxide (Aldrich) was added to a 500 ml round bottom flask. The Al[CH₃)₃CO]₃ was dissolved in a solution of 100 ml toluene (Fisher) and 40 ml t-butanol (Fisher) to form a clear colorless solution. A solution of 0.216 ml (0.0120 mole) distilled water in 70 ml absolute ethanol (Aaper Alcohol and Chemical Co.) was then added dropwise to the solution to form aluminum hydroxide gel. The reaction mixture was then stirred at room temperature for 10 hours. During this time the reaction mixture remained a clear colorless gel, but was dilute enough to maintain a liquid state.

2. Supercritical Removal of the Solvents.

The hydroxide sol-gel was transferred to a glass liner of a Parr autoclave. The autoclave was first flushed with nitrogen, and then (with nitrogen) pressurized to 100 PSI. The reactor was slowly heated (1° C./min) with stirring from room temperature to 265° C. As the autoclave was heating, the pressure was increased from 100 PSI to 1100 PSI. Once the autoclave reached 265° C., the reactor was vented to the atmosphere very quickly removing the solvent vapors, (which took about 1 minute). Next, the furnace was remo the bomb was flushed with the bomb was flushed with nitrogen for 10 minutes to remove remaining solvent vapors. The autoclave was then allowed to cool to room temperature.

3. Thermal Conversion of Aluminum Hydroxide to Aluminum Oxide.

Data from thermogravimetric analysis (TGA) confirmed that the aluminum hydroxide to aluminum oxide conversion occured between 400-450° C. The fluffy, white aluminum hydroxide powder was placed into a Schlenk tube, connected to a vacuum line and surrounded by a furnace. The Schlenk tube was evacuated at room temperature for 1 hour. Next the Schlenk tube was slowly heated from room temperature to 500° C. while under dynamic vacuum. After the heat treatment was complete the furnace was turned off and the Schlenk tube was allowed to cool to room temperature, still under dynamic vacuum. After heat treatment the aluminum oxide had a light gray color.

Preparation of Nanocrystalline (NC) Al₂O₃/MgO

In this example, the synthesis and isolation of nanocrystalline Al₂O₃/MgO powder was carried out, which involved first preparing an aluminum alkoxide solution, and a magnesium alkoxide solution. The two alkoxide solutions were then mixed in the desired molar ratio, and this solution was then allowed to react with a mixture of water in ethanol, and a hydroxide gel was formed. Upon solvent removal, a fine powder was obtained which was then heat treated under dynamic vacuum. The reactions involved in the preparation are shown below.

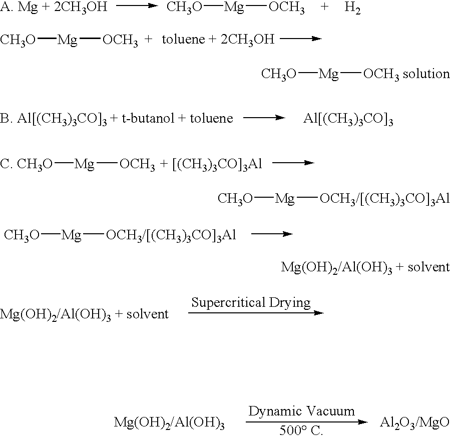

The preparation consisted of three main steps:

1. Synthesis of the Aluminum/Magnesium Hydroxide Gel.

The chemicals used in the synthesis were obtained from a commercial source without further purification. The magnesium methoxide solution was first prepared by adding 0.500 g (0.020 mole) of Mg (Fisher) (which had been sandpapered, wiped clean with an acetone wet kimwipe, and cut into small pieces) to a 200 ml round bottom flask under argon atmosphere. 50 ml methanol (Fisher) was added to the Mg, and this mixture was reacted and stirred overnight to form a clear colorless solution. 50 ml of toluene was then added to this solution, and the solution was stirred for 2 hours.

An aluminum tri-tert-butoxide solution was prepared by dissolving 1.00 g (0.0040 ml) aluminum tri-tert-butoxide (Aldrich) in 100 ml toluene (Fisher) and 40 ml t-butanol (Fisher) under an argon atmosphere in a 500 ml round bottom flask. A clear colorless solution was formed.

Lastly, the alkoxide solutions were mixed to give desired molar percentages, and then hydrolyzed. A solution containing a stoichiometric amount of distilled water in 70 ml absolute ethanol (Aaper Alcohol and Chemical Co.) was added dropwise to the alkoxide solutions to form the aluminum hydroxide/magnesium hydroxide gel. The reaction mixture was stirred at room temperature for 10 hours. During this time the reaction mixture remained a clear, colorless, liquid-like gel.

2. Supercritical Removal of the Solvents.

The hydroxide sol-gel was transferred to a glass liner of a Parr autoclave. The autoclave was first flushed with nitrogen, and the nitrogen was given an initial pressure of 100 PSI. While stirring, the reactor was slowly heated (1° C./min) from room temperature to 265° C. As the autoclave was heating, the pressure increased from 100 PSI to 1100 PSI. Once the autoclave reached 265° C., the reactor was vented to the atmosphere very quickly removing the solvent vapors, which took about 1 minute. Next the furnace was removed and the bomb was flushed with nitrogen for 10 minutes to remove remaining solvent vapors. The autoclave was then allowed to cool to room temperature.

3. Thermal Conversion of Aluminum Hydroxide/Magnesium Hydroxide to Aluminum Oxide/Magnesium Oxide.

Data from thermogravimetric analysis (TGA) confirmed that the hydroxide to oxide conversion occurred between 400-450° C. The fluffy, white aluminum/magnesium hydroxide powder was placed into a Schlenk tube, connected to a vacuum line and surrounded by a furnace. The Schelnk tube was evacuated at room temperature for 1 hour. The tube then was slowly heated from room temperature to 500° C. while under dynamic vacuum. After the heat treatment was complete, the furnace was turned off and the Schlenk was allowed to cool to room temperature, still under dynamic vacuum. After heat treatment, the aluminum/magnesium oxide had a light gray color.

Commercial aluminum oxide was purchased from Baker Analytical (CM—Al₂O₃) and commercial magnesium oxide was purchased from Aldrich (CM—MgO).

Characterization

(1) Transmission electron microscopy (TEM). TEM studies were performed by adding dry ethanol to the heat-treated Al₂O₃ and sonicating this slurry for 5 minutes using a Branson 1210 sonicator. A drop of this slurry was then placed onto a carbon coated copper grid. The TEM experiments were performed using a Philips 201 TEM and a Philips CM12 TEM.

(2) Brunauer-Emmet-Teller (BET). Surface area measurements were performed using BET methods. These measurements were conducted using both Micromeritics Flowsorb II 2300 and Quantachrome NOVA 1200 instrumentation. The samples were first outgassed at the desired temperature, and then allowed to cool to room temperature. Next they were further cooled to 77K and exposed to nitrogen/helium mixture (30% N₂, 70% He) where the adsorption of nitrogen molecules occurred. The amount of nitrogen adsorbed as a monolayer was measured. From the number of molecules adsorbed, and knowing the area occupied by each, the surface area was directly calculated.

(3) Powder X-ray Diffraction (XRD). For XRD studies, the powder samples were heat treated under vacuum immediately before being placed onto the sample holder. The instrument used was a Scintag XDS 2000 spectrometer using CuKα radiation with 2θ range of 20-85° , although an equivalent unit could be used. CuKα radiation was the light source used with applied voltage of 40 KV and current of 40 mA. The two theta angles ranged from 20° to 85° with a speed of 2° per minute. Spectra were run with a 0.02° step and a 0.08s step count with slit widths 2, 4 and 1, 05. The crystallite size was then calculated from the XRD spectra using the Debye-Scherrer equation by measuring the peak with a half maximum.

In particular, the sample was placed in a plastic sample plate having a depth of 2 nm. The powder was spread evenly over the sample plate, then pressed with a microscope slide to insure that the sample was flat and homogeneous. The sample plate was held in the instrument using a spring-loaded sample holder located between the X-ray gun and the detector. The sample was then placed on the holder and the holder was allowed to rise gently until the sample place was clamped in position.

As used herein, “XRD analysis” refers to this procedure.

(4) Infrared Spectroscopy (FT-IR). FT-IR was used to observe solvent removal during the heat treatment process. These experiments were conducted on an RS-1 FTIR spectrometer from Mattson with a liquid nitrogen cooled MCT detector. Heat-treated samples of NC—Al₂O₃and CM—Al₂O₃ were made into KBr pellets and studied.

(5) Thermogravimetric Analysis (TGA). TGA was used to determine the conversion of Al(OH)₂ to Al₂O₃ during heat treatment. These studies were conducted under a nitrogen flow. To measure the weight loss, the Al₂O₃ samples were placed onto a basket and heated at a rate of 10°/min from room temperature to 700° C. The instrument used was a thermogravimetric analyzer TGA-50 from the Shimadzu Company.

(6) Elemental Analysis. After heat treatment, the Al₂O₃ was transferred to glass vials, placed under argon atmosphere, and analyzed for Al, C, and H. The amount of oxygen was obtained by subtracting the sum of Al, C, and H from 100.

Adsorption Studies

1. Reaction of Al₂O₃, and Al₂O₃/MgO with CCl₄

2Al₂O₃+3CCl₄→3CO₂+2Al₂Cl₆

2MgO+CCl₄→CO₂+2MgCl₂

The chemical reactivity of the metal oxides was determined by reacting the metal oxides with CCl₄. The reactions were conducted in a U-tube that was connected to a gas chromatograph (GOW-MAC gas chromatograph series 580). The U-tube was made of Pyrex and connected between the injector port and the column (Alltech Chromosorb W-HP). An oxide sample (0.100 gram) was placed in the U-tube between two small plugs of quartz wool. The U-tube was heated to 500° C. and the injector port was kept at 100° C. 2 μl of CCl₄ were injected every seven minutes. Any CO₂ coming off the sample, or CCl₄ that was not destroyed, was then sent via helium (20 cc/min) through the column (90° C.) to be separated. Any CO₂ or CCl₄ was detected by a thermal conductivity detector (120° C.) and peak areas recorded. Injections of CCl₄ were made until the oxide bed had been exhausted.

2 Sulfur Dioxide Adsorption

A quartz spring balance was used to measure the adsorption of SO₂ onto Al₂O₃ and Al₂O₃/MgO. The apparatus consisted of a basket used to hold the sample and was attached to a quartz spring. The basket and the spring were closed within the vacuum line. The SO₂ gas tank was also attached to the vacuum line. As the SO₂ adsorbed onto the metal oxide in the basket, the weight change caused the spring to move, and this movement was noted by the telescope. Once calibrated, the telescope was accurate to ±0.1 mg.

Due to the electrostatic properties of the fine powders, it was found to be much easier and more accurate to work with granules. Using granules helped to eliminate losses during transfers, weighing, and applying vacuum. Therefore, the samples were first pressed into pellets at 1000 pounds load, then crushed and sifted through a mesh to achieve granules having a size of about 0.250 mm to 1.17 mm. By using a relatively low pelletization pressure, only a small change in surface area resulted.

Granules (100 mg) of oxides were placed into the basket on the spring balance. The samples were placed under dynamic vacuum for 1 hour at room temperature. After evacuation, the vacuum line was closed to the pump and the spring position was noted. The vacuum line including the spring balance was filled with SO₂ gas to the desired pressure. The spring position was noted over the next hour. The vacuum line was then evacuated for 100 minutes to remove all physisorbed species. After the evacuation, the spring position, which indicated the presence of remaining strongly chemisorbed species was noted again.

3. Destructive Adsorption of Diethyl 4-Nitrophenyl Phosphate

In this example, the destructive adsorption of diethyl 4-nitrophenyl phosphate (DNPP, also called paraoxon) and considered a chemical warfare mimic), was carried out to determine the capacity of the oxide to dissociatively chemisorb a polar organophosphorous compound. A 0.100 g sample was placed into a 250 ml round bottom flask that had been flushed with argon. 100 ml dry pentane was then added to the flask, and the mixture was stired. 8 μl paraoxon was added to the flask. By extracting samples at desired intervals, ultraviolet/visible spectroscopy (SIM Aminco Milton Roy 3000 array) was used to monitor the disappearance of paraoxon at 270 nm wavelength, by extracting samples at desired intervals. The destructive adsorption reaction was monitored every 20 minutes for the first 3 hours, and then again at 20 hours. The powder was filtered and FTIR was used to detect adsorbed species on the solid. The used solid was then washed with 10 ml portions of CH₂Cl₂, IR analysis of the extracted CH₂Cl₂ showed that no adsorbed species were removed.

Preparation of the Aluminum Oxide

Several experiments were conducted using various the starting materials, solvents, and stirring times; all of which were found to have an effect on the surface area of the resulting sample. Results are shown in Table 1.

TABLE 1
Aluminum Oxide Preparation Variables

| | | | | | Surface |
|---|---|---|---|---|---|
| Sample | | | Stirring | | Area |
| # | Starting Material | Solvent | Time | | (m²/g) |
| 1 | Aluminum | Toluene/Ethanol | 2 | hr | 352 |
| | Triethoxide | (100 ml/40 ml) | | | |
| 2 | Aluminum | Toluene/Ethanol | 10 | hr | 385 |
| | Triethoxide | (100 ml/40 ml) | | | |
| 3 | Aluminum | Toluene/Isopropanol | 2 | hr | 224 |
| | Isoproproxide | (100 ml/40 ml) | | | |
| 4 | Aluminum | Toluene/Isopropanol | 10 | hr | 243 |
| | Isoproproxide | (100 ml/40 ml) | | | |
| 5 | Aluminum | Toluene/Butanol | 2 | hr | 392 |
| | Tributoxide | (100 ml/40 ml) | | | |
| 6 | Aluminum | Toluene/Butanol | 10 | hr | 369 |
| | Tributoxide | (100 ml/40 ml) | | | |
| 7 | Aluminum Tri-tert- | Toluene/t-Butanol | 2 | hr | 743 |
| | butoxide | (100 ml/40 ml) | | | |
| 8 | Aluminum Tri-tert- | Toluene/t-Butanol | 10 | hr | 810 |
| | butoxide | (100 ml/40 ml) | | | |
| 9 | Aluminum Tri-tert- | Toluene/t-Butanol | 20 | hr | 735 |
| | butoxide | (100 ml/40 ml) | | | |
| 10 | Aluminum Tri-tert- | Toluene/t-Butanol | 10 | hr | 673 |
| | butoxide | (50 ml/40 ml) | | | |
| 11 | Aluminum Tri-tert- | Toluene/t-Butanol | 10 | hr | 779 |
| | butoxide | (150 ml/40 ml) | | | |

Sample #8, using using aluminum tri-tert-butoxide as the starting material exhibited the highest surface area. Stirring time was found to be a relevant factor in determining surface area. Enough time had to be allowed for hydrolysis to occur, but too much stirring time resulted in lower surface areas. The amount of solvent used was also studied and found to have a role in the surface area. In samples 8, 10, and 11 it was found that decreasing the amount of toluene from 100 ml to 50 ml resulted in a significant decrease in surface area, going from 786 to 673 m²/g. When the amount of solvent was increased from 100 ml to 150 ml as in samples 10, and 11, the surface area only slightly decreased from 786 to 779 m²/g.

Activation of the Aluminum Oxide (Thermal Dehydration)

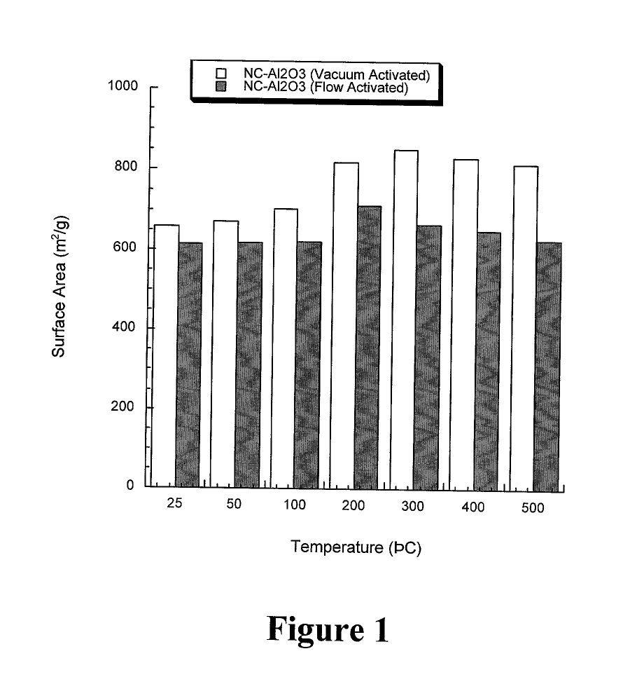

In this experiment, aluminum oxide was activated under either argon flow, or dynamic vacuum. The Al₂O₃ surface areas for each method of activities are shown in FIG. 1. The Al₂O₃ surface area is significantly higher for the sample activated under dynamic vacuum then argon flow. Generally, during activation, the surface area increases, then goes through a maximum, and then decreases. The small decrease in surface area at temperatures above 400° C. can be explained by sintering.

Aluminum Oxide Characterization.

Through careful characterization of the Al₂O₃ samples, it was discovered that the NC—Al₂O₃ samples had morphology different from that of the commercial (CM) Al₂O₃ samples.

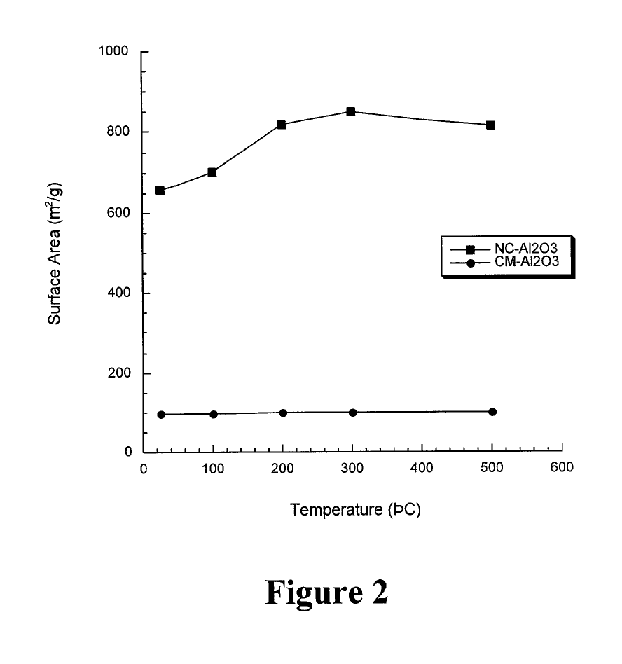

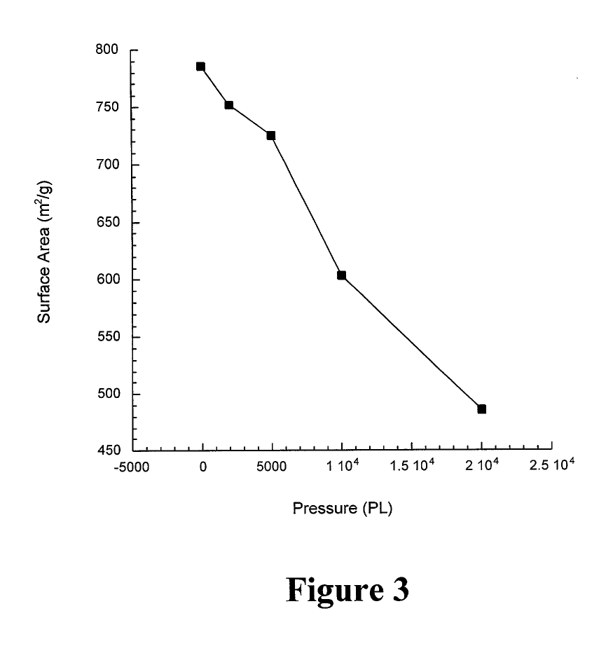

(1) Brunauer-Emmet-Teller Method (BET). Commercial Al₂O₃ is most commonly prepared by high temperature methods, and has surface areas within the range of 100-110 m²/g. The NC—Al₂O₃ samples typically possessed surface areas within the range of 790-810 m²/g after heat treatment at 500° C. When heated at higher temperatures the crystallites began to sinter, and surface areas decreased. FIG. 2 shows the heat treatment temperature dependence observed in NC—Al₂O₃ compared to CM—Al₂O₃.

Using BET, data on the Al₂O₃ pore structures was obtained. The average NC—Al₂O₃ sample after heat treatment possessed pores that were 10 nm in diameter, held 2.05 cc/g volume, and had a cylindrical pore structure that was open at both ends. See Table 2.

TABLE 2
Surface area, pore volume and diameter of CM-Al₂O₃ and NC-Al₂O₃.

| | | Average | | Average | |
|---|---|---|---|---|---|
| Sample | Surface Area | Pore Volume | | Pore Diameter | |
| CM-Al₂O₃ | 103 m²/g | 0.19 | cc/g | 7.4 | nm |
| NC-Al₂O₃ | 805 m²/g | 2.1 | cc/g | 11 | nm |

Pellets of the NC—Al₂O₃ were prepared and heat treated at 500° C. Pellets were pressed under various pressures and then studied by BET methods to measure the effects of pressure surface area, pore diameter, pore volume, and pore shape. The pressures tested in pounds load (PL) were 2000 PL, 5000 PL, 10,000 PL, and 20,000 PL. FIG. 3 shows how the surface area varied with pressure. Before being pressed, the samples had about 800 m²/g surface area. When pressed at 2000 PL, the surface area fell to 752 m²/g, and fell to 486 m²/g at 20,000 PL. The pore diameter also changed with increasing pressure. When not pressed, the samples have 10.8 nm pore openings. Under 2000 PL, the pore openings decreased slightly to 10.7 nm and then dropped to 7 nm at 20,000 PL. Pore volume also changed with pressure, but not as drastically as the average pore diameter. Before being pressed, the samples had 2.05 cc/g volume, and after being pressed at 2000 PL, the volume dropped slightly to 1.85 cc/g. However, after being pressed at 10,000 PL, the volume decreased to 1.22 cc/g and remained at that level even after being pressed at 20,000 PL. Table 3 shows how the pore shape of the NC—Al₂O₃ sample changed with increasing pressure, according to De Boer's hysteresis.

TABLE 3
Pressure and resulting pore shape for NC-Al₂O₃.

| Pressure (PL) | | Pore Shape |
|---|---|---|
| 0 | PL | Cylindrical Pores Open at Both Ends |
| 2,000 | PL | Cylindircal Pores Open at Both Ends |
| 5,000 | PL | Cylindrical Pores Open at Both Ends |
| 10,000 | PL | Cylindrical Pores Open at Both Ends |
| 20,000 | PL | Tapered or Wedged Shaped Pores with Narrow Necks, |
| | | Open at One or Both Ends |

Before any pressure was applied, the sample had a pore structure consisting of cylindrical pores open at both ends. When pressure was applied, this pore structure remained, until when, at 20,000 PL, it was replaced with slit shaped pores, the space between parallel plates.

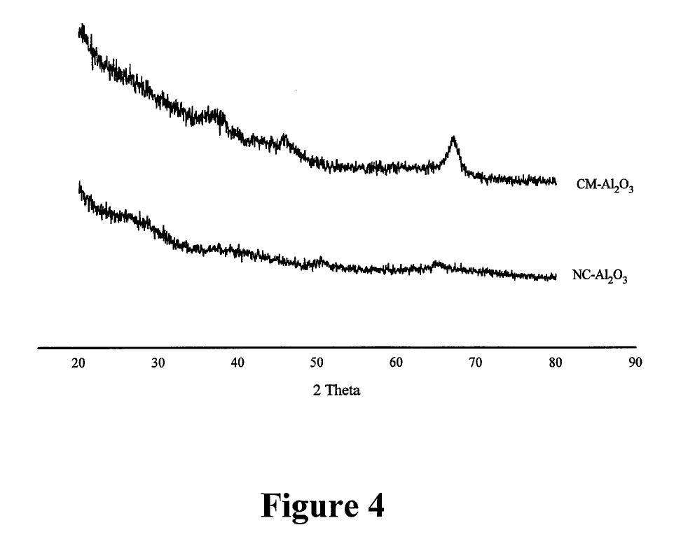

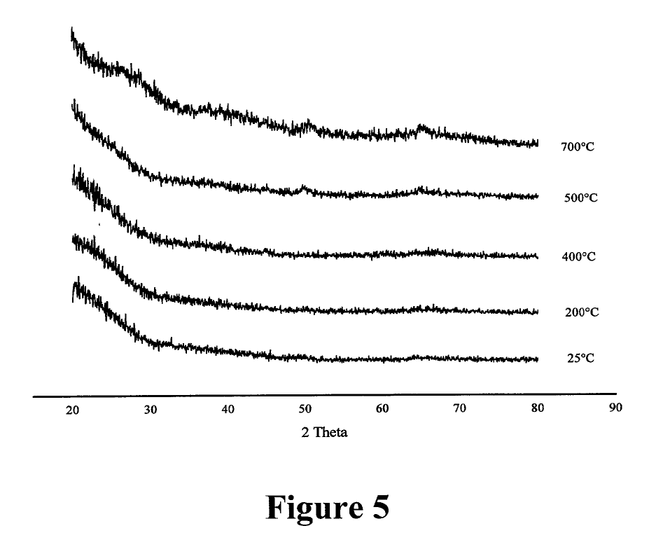

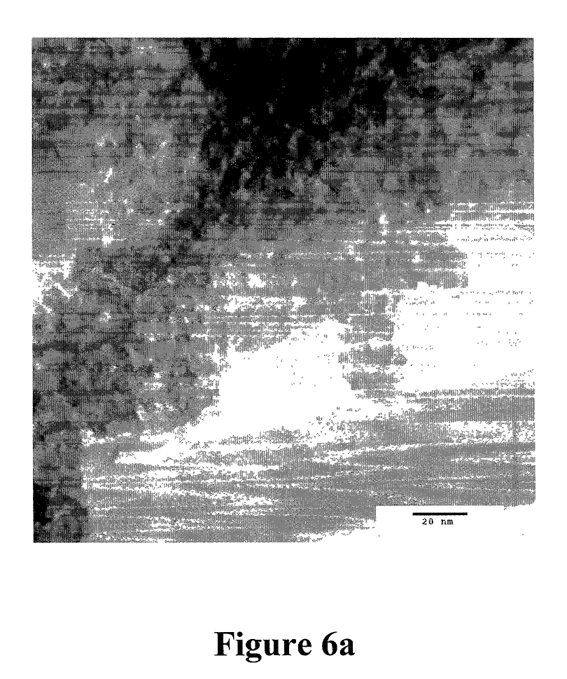

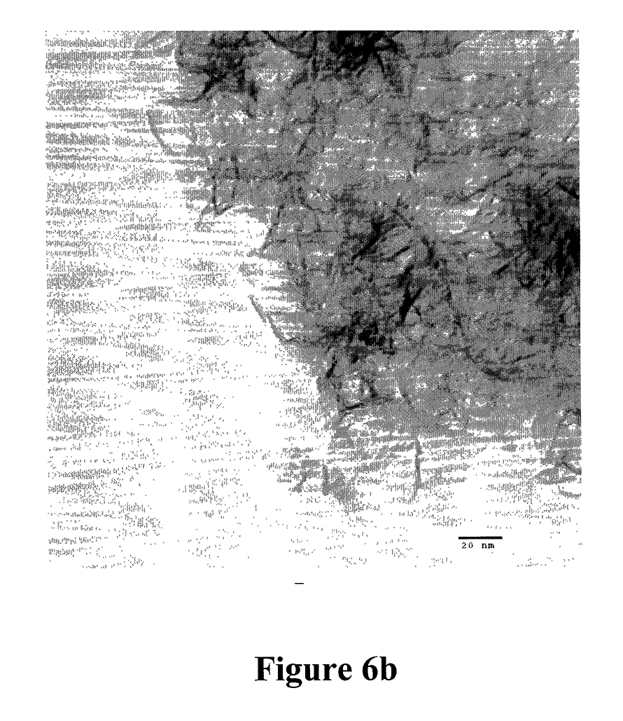

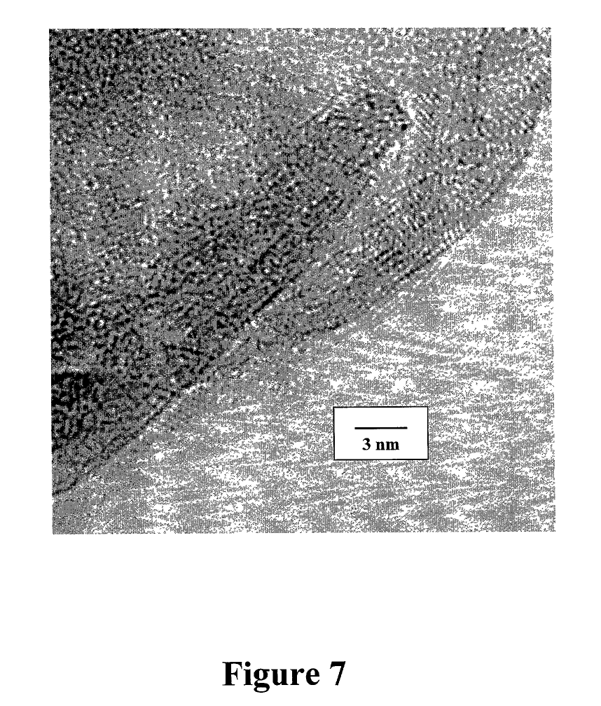

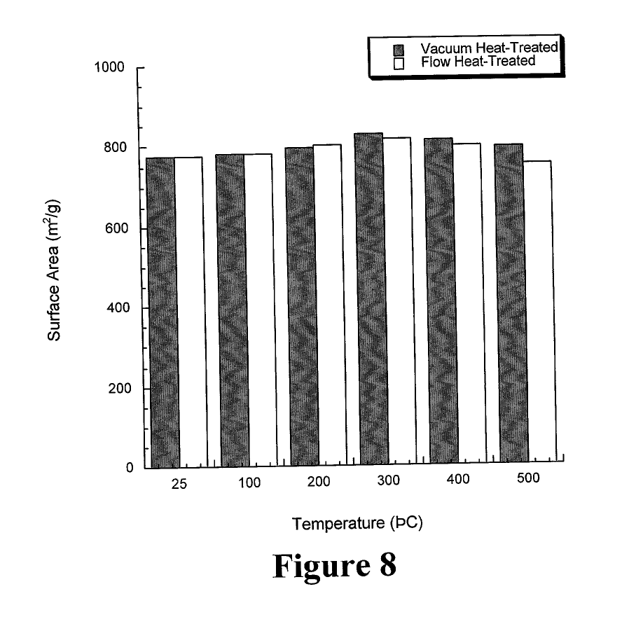

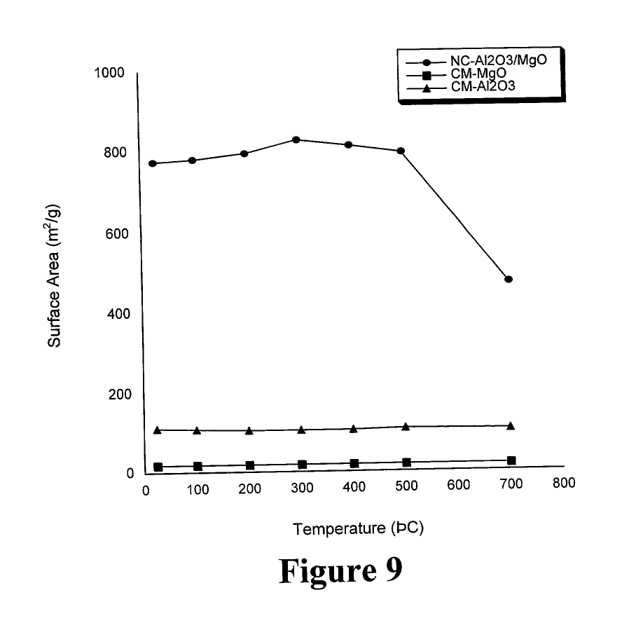

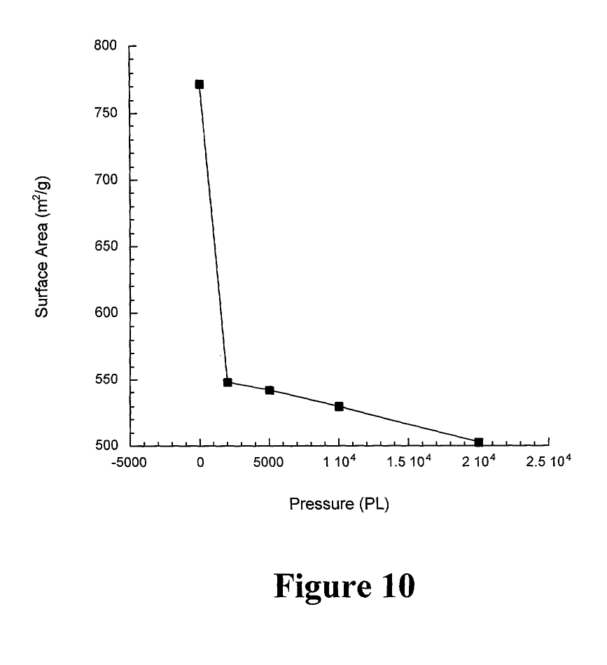

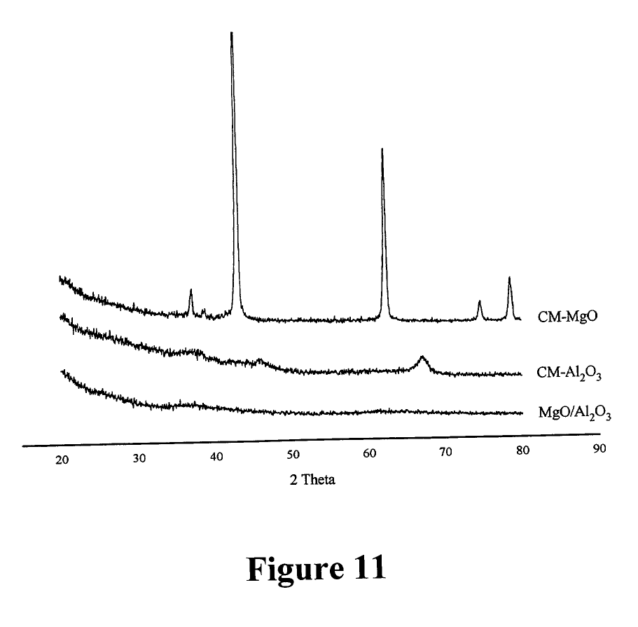

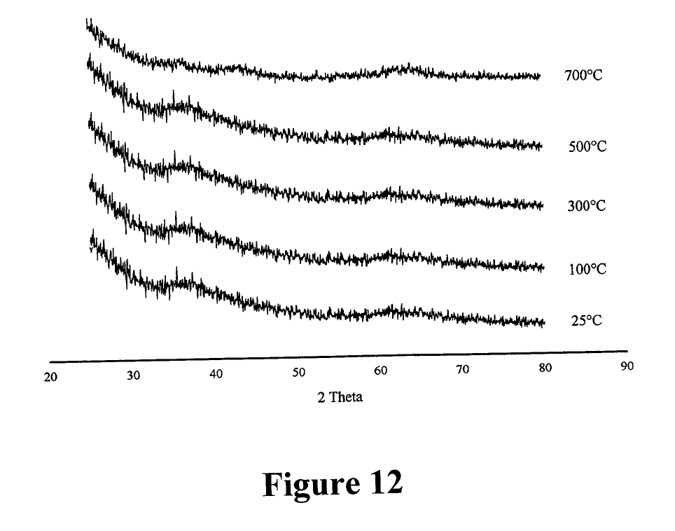

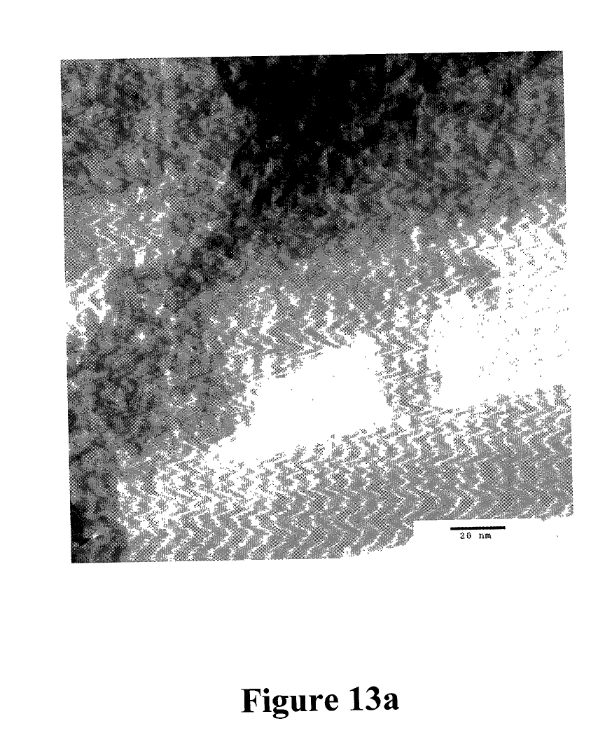

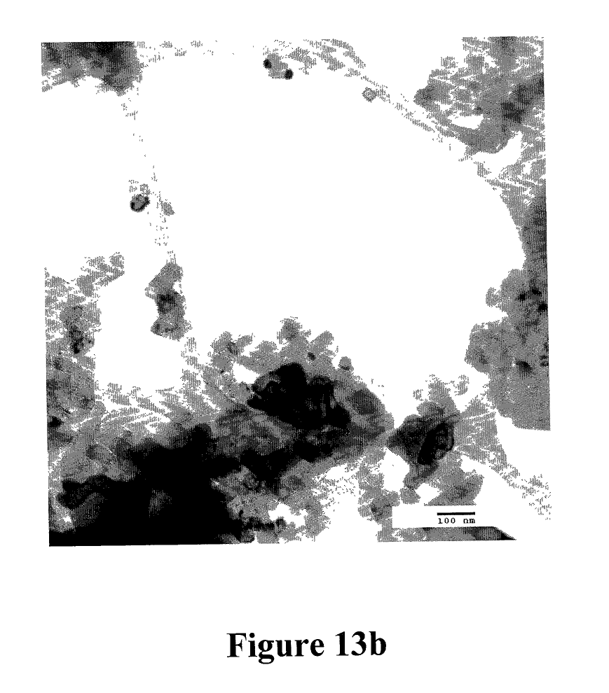

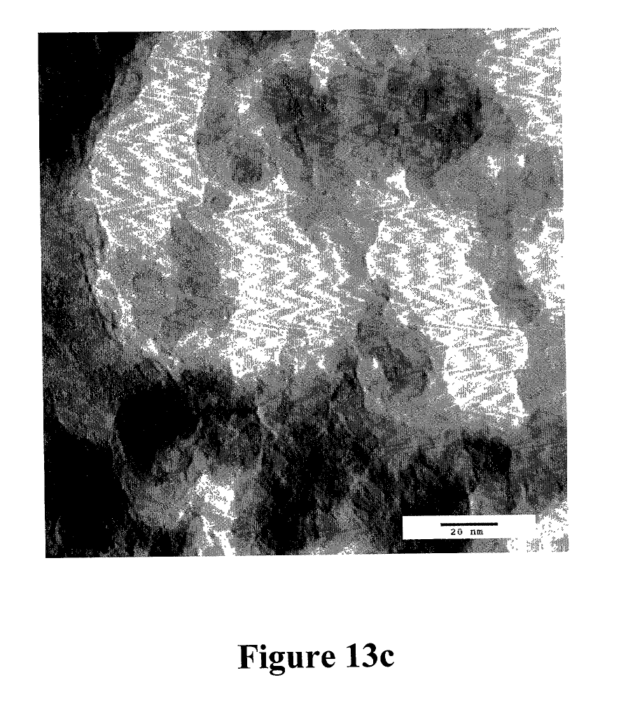

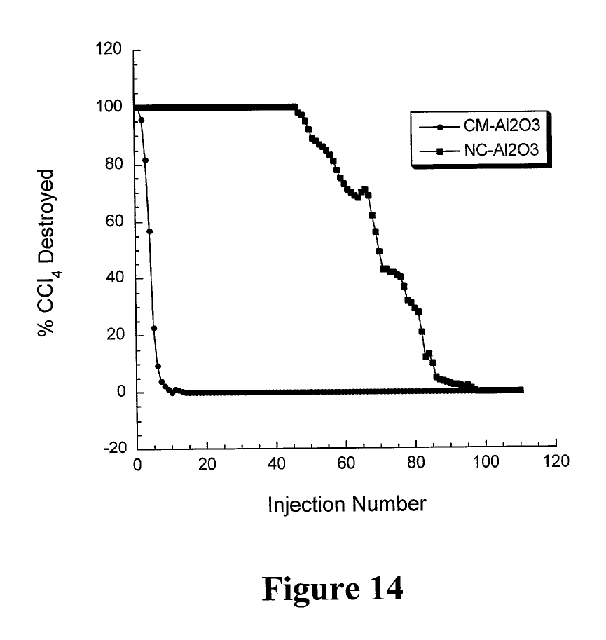

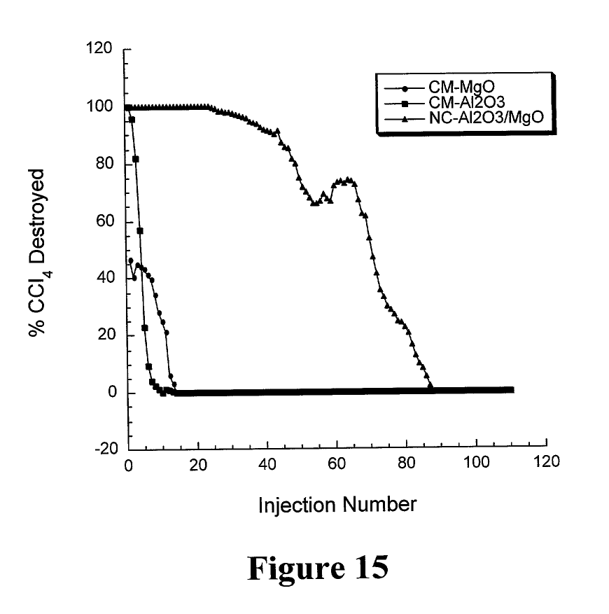

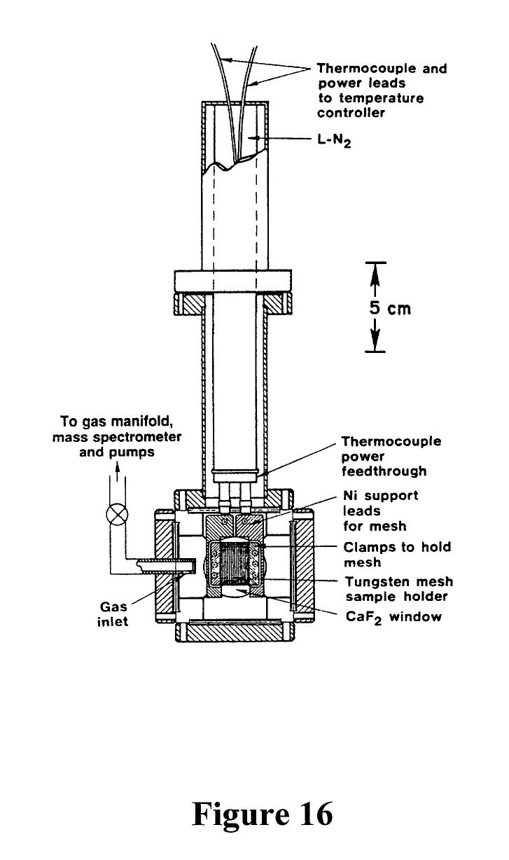

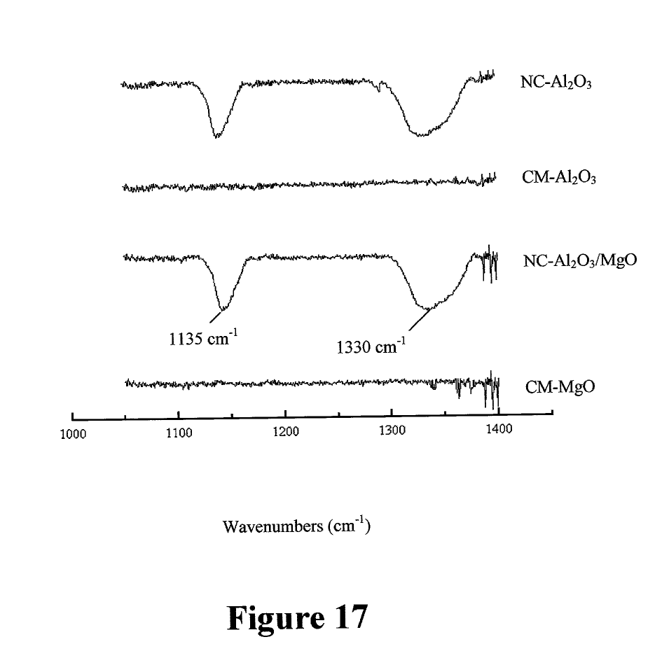

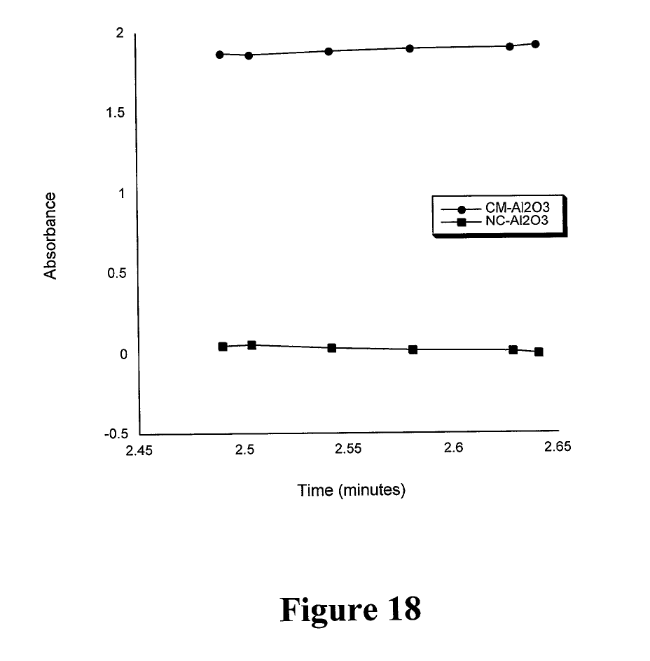

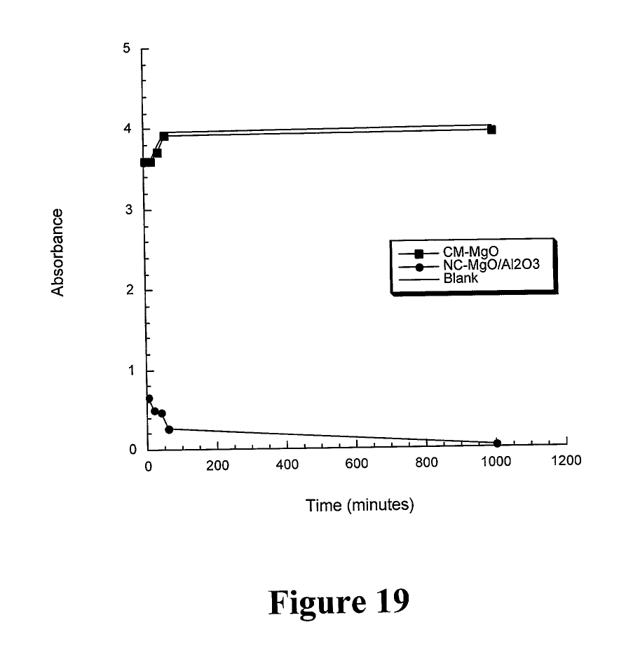

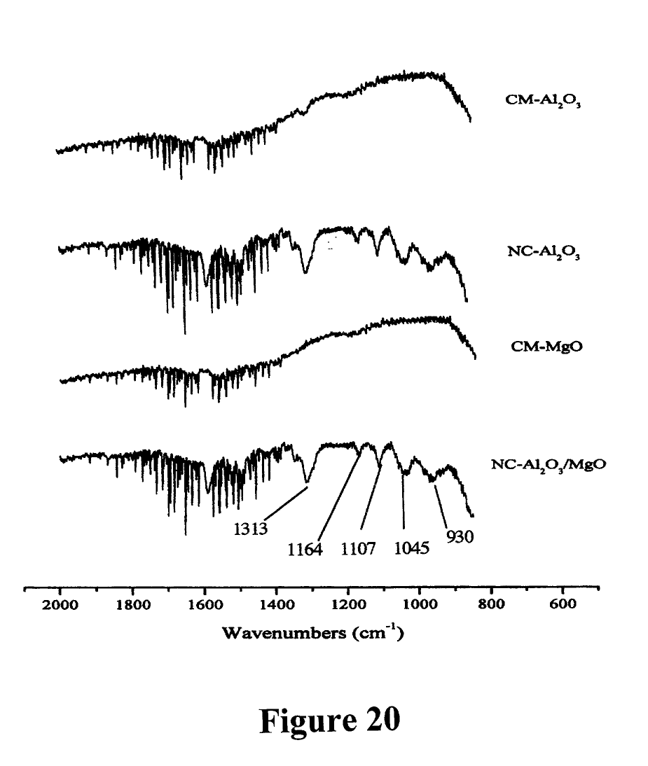

(2) X-ray Diffraction (XRD). From XRD, diffraction patterns that showed the NC—Al₂O₃ sample to be less crystalline than the commercial Al₂O₃ samples. The NC—Al₂O₃ had a completely amorphous pattern (FIG. 4) due to particle size broadening which occurs when a sample is made up of very small cyrstallites. Using the Scherrer equation, the crystallites size may be calculated based on the broadness of the peaks.

Even as the temperature was increased, the crystallite size of NC—Al₂O₃ was not able to be determined from the diffraction patterns. The data showed that the NC—Al₂O₃ had a significantly smaller crystallite size than the commercial Al₂O₃ samples. The average crystallite size for NC—Al₂O₃ activated at 500° C. was less then 2 nm, while the average crystallite size for CM—Al₂O₃ was 19 nm. FIG. 5 shows the x-ray diffraction patterns of NC—Al₂O₃ heated from 25° C. to 700° C. The conversion of Al(OH)₃, could not be determined by viewing the XRD patterns.

(3) Infrared Spectroscopy (IR). IR was used to study the aluminum oxide powder during heat activation. The heat-treated samples were ground with KBr, and pressed into pellets. IR spectra were taken after heat treatment at 25° C., 50° C., 100° C., 150° C., 200° C., 250° C., 300° C. 400° C. and 500° C. A gradual loss of water, and solvent could be seen from 25° C. to 500° C. Even after 500° C. heat treatment, some residual —OH groups remained.

(4) Thermogravimetric Analysis (TGA). Using TGA, weight loss under nitrogen flow was observed to be about 35%. The weight loss was found to be the same when conducted in air. One major weight loss occurs between 420° C. to 460° C., and was due to the conversion of Al(OH)₃ to Al₂O₃, and the removal of the water. Theoretically, the conversion of Al(OH)₃ to Al₂O₃ should yield a 35% weight loss, whereas the weight loss would be 23% if the Al(OH)₃ were converted to AlOOH.

(5) Transmission Electron Microscope (TEM). FIGS. 6a and 6b show TEM photographs of CM—Al₂O₃ and NC—Al₂O₃ respectively. The CM—Al₂O₃ sample (FIG. 6a) appeared as a grainy material with crystallites greater than 10 nm. The NC—Al₂O₃ sample (FIG. 6b) consisted of crystallites having an average crystallite size of about 5 nm, but of a different morphology. By compiling data from XRD, TEM, and BET, it was concluded that the NC—Al₂O₃ samples are made up of crystallites having an average size of less than 2 nm. The NC—Al₂O₃ sample was further investigated using HRTEM which confirmed that the average crystallite size was less than 2 nm, and disordered (FIG. 7).

(6) Elemental Analysis. Table 4 shows the elemental analysis results of NC—Al₂O₃ that was preheat-treated to 500° C. under dynamic vacuum. These data indicated the presence of some residual OH/H₂O. IR analysis indicated the presence of adsorbed CO₂. If CO₂ and surface OH are assumed to be the only adsorbed species, a formula Al₂O_{2.7} (OH)_{0 53}(CO₂)_{0 03} fits the data (oxygen by difference).

TABLE 4
Elemental anaylsis for NC-Al₂O₃

| Element | % Calculated | % Experimental |
|---|---|---|
| Aluminum | 52.9% | 47.1% |
| Oxygen | 47.1% | 51.9% |
| Carbon | 0% | <0.50% |
| Hydrogen | 0% | <0.50% |

Preparation of the Aluminum/Magnesium Oxide

In this experiment, the quantity of solvent, stirring time, and molar ratios were varied. all of the variables were found to have an effect on the surface area of the resulting sample. Some of the results are shown in Table 5.

TABLE 5
Alumimum/Magnesium Oxide Preparation Variables

| | Molar Ratio | | | | | Surface Area |
|---|---|---|---|---|---|---|
| Sample # | Al₂O₃/MgO | Solvent ml | | Stirring Time | | (m²/g) |
| 1 | 1/1 | 20 | ml | 1 | hr | 559 |
| 2 | 1/1 | 70 | ml | 1 | hr | 762 |
| 3 | 1/1 | 120 | ml | 1 | hr | 743 |
| 4 | 1/1 | 70 | ml | 10 | hr | 815 |
| 5 | 1/1 | 70 | ml | 20 | hr | 796 |
| 6 | 1/2 | 70 | ml | 10 | hr | 775 |
| 7 | 2/1 | 70 | ml | 10 | hr | 834 |

Sample number seven, using a 2:1 Al₂O₃ to MgO ratio, produced Al₂O₃/MgO having the higest surface area. For 1:1 Al₂O₃ to MgO samples, stirring time was found to be a factor in determining surface area. Sufficient stirring time was needed for hydrolysis to occur, but too much stirring time resulted in lower surface areas. The amount of solvent (ethanol) used in the hydrolysis step was also studied and found to have an important role in the surface area. Decreasing the amount of ethanol from 70 ml to 20 ml as in samples 1 and 2, resulted in a significant decrease in surface area, going from 762 to 559 m²/g. When increasing the amount of solvent from 70-170 ml as in samples 2, and 3, the surface area decreased from 762 to 743 m²/g.

Activation of the Aluminum/Magnesium Oxide (Thermal Dehydration)

Aluminum/magnesium oxide was activated under either argon flow or dynamic vacuum. The surface areas produced for each activation method are shown in FIG. 8. The particle surface area is slightly higher for the sample activated under dynamic vacuum than those activated under argon flow. Generally, during activation the surface area increased, then went through a maximum, and then decreased. The small decrease in surface area at temperatures above 400° C. can be explained by sintering.

(1/1) Aluminum Oxide Magnesium Oxide Characterization

Careful characterization of the (1/1) (Molar Ratio) Al₂O₃/MgO samples demonstrated that the NC—Al₂O₃/MgO samples had morphology different from that of the commercial (CM) Al₂O₃ and MgO samples.

(1) Brunauer-Emmet-Teller Method (BET). The NC-(1/1) Al₂O₃/MgO samples which were heat treated at 500° C. typically possessed surface areas within the range of 770-810 m²/g. When heated at higher temperatures, the crystallites began to sinter, and as a result, the surface areas decreased. FIG. 9 shows the heat treatment temperature dependence observed in NC-53(1/1) Al₂O₃/MgO compared to CM—Al₂O₃ and CM—MgO.

Using BET, pore structure data was obtained. The average NC-(1/1)Al₂O₃/MgO sample after heat treatment possessed pores that were 10 mn in diameter, had a volume of 1.90 cc/g and had a cylindrical pore structure that was open at both ends.

In addition, NC SrO, Sr(OH)₂, mixed Mg/Sr, Al/Sr and tertiary Al/Mg/Sr materials were prepared by the same techniques described above for the Al₂O₃/MgO systems, except that the appropriate Sr reagents were employed. Table 6 below gives data characterizing the foregoing compositions, together with data for corresponding CM materials.

TABLE 6
Surface area, pore volume and diameter of nanocrystalline samples
compared to commercially available samples.

| | Surface Area | Average Pore | Average Pore |
|---|---|---|---|
| Sample | (m²/g) | Volume (cc/g) | Diameter (nm) |
| CM-Al₂O₃ | 103 | 0.19 | 7.4 |
| CM-MgO | 18.7 | 0.077 | 16 |
| NC-Al₂O₃ | 805 | 2.1 | 11 |
| NC-Al₂O₃/MgO^{b} | 793 | 1.9 | 11 |
| NC-MgO^{a} | 400 | 0.90 | 9.0 |
| CM-Sr0 | 1.1 | 0.0055 | 19 |
| NC-SrO | 19 | 0.06 | 13 |
| CM-Sr(OH)₂ | 4.0 | 0.0083 | 8.2 |
| NC-Sr(OH)₂ | 8.1 | 0.0076 | 27 |
| NC-Mg(OH)₂/Sr(OH)₂ | 180 | 0.5 | 11 |
| NC-Mg(OH)₂ | 460 | 1.6 | 9.0 |
| NC-MgO/SrO | 135 | 0.38 | 11 |
| NC-Al(OH)₃/Sr(OH)₂ | 175 | — | — |
| NC-Al₂O₃/SrO | 137 | 0.52 | 15 |
| NC-Al₂O₃/MgO/SrO | 195 | 0.51 | 11 |
| NC- | 225 | 0.54 | 9.8 |
| Al(OH)₃/Mg(OH)₂/ | | | |
| Sr(OH)₂ | | | |

^{a}Also referred to as AP-MgO for aerogel prepared.
^{b}One mole Al₂O₃ to one mole MgO.

Pellets of the NC-(1/1) Al₂O₃/MgO heat treated at 500° C. were prepared. The pellets were pressed at various pressures and then studied by BET methods to determine the effects of pressure on surface area, pore diameter, pore volume, and pore shape. The pressures tested in pounds load (PL) were 2,000 PL, 5,000 PL, 10,000 PL, and 20,000 PL. FIG. 10 shows how the surface area varied with pressure. The unpressed samples had surface areas of 772 m²/g when pressed at 2,000 PL and the surface area fell to 547 m²/g, and at 20,000 PL, the surface area fell to 502 m²/g. The pore diameter was also affected by pressure. The unpressed samples had 10.8 nm pores which decreased to 7.76 nm at 2000 PL, and then dropped to 6 nm at 20,000 PL. Pore volume also changed with pressure, but not as drastically as the diameter or the surface area. The unpressed samples had 1.90 cc/g volume, and after being pressed at 2000 PL the volume dropped to 0.742 cc/g, at 10,000 PL, the volume decreased to 0.635 cc/g and remained at that level even after being pressed at 20,000 PL. Table 7 shows how the pore shape of the NC—Al₂O₃/MgO sample changed with increasing pressure, according to De Boer's hysteresis.

TABLE 7
Pressure and resulting pore shape for NC-Al₂O₃/MgO.

| Pressure (PL) | | Pore Shape |
|---|---|---|
| 0 | PL | Cylindrical Pores Open at Both Ends |
| 2,000 | PL | Cylindircal Pores Open at Both Ends |
| 5,000 | PL | Cylindrical Pores Open at Both Ends |
| 10,000 | PL | Tapered or Wedged Shaped Pores with Narrow Necks, |
| | | Open at One or Both Ends |
| 20,000 | PL | Tapered or Wedged Shaped Pores with Narrow Necks, |
| | | Open at One or Both Ends |

Before any pressure was applied, the sample had a pore structure consisting of cylindrical pores open at both ends. This pore structure remained until 10,000 PL, where the cylindrical pores were transformed into tapered or wedged shaped pores with narrow necks, open at one or both ends.

(2) X-ray Diffraction. XRD diffraction patterns were obtained that showed the NC—Al₂O₃/MgO sample to be less crystalline than the commercial MgO and Al₂O₃ samples. The NC—Al₂O₃/MgO had a completely amorphorus pattern (FIG.11), due to severe particle size broadening.

The crystallite size of NC-(1) Al₂O₃/MgO could not be determined from the diffraction patterns, even as the temperature was increased. The results show that the NC—Al₂O₃/MgO has a significantly smaller crystallite size than the commercial MgO and Al₂O₃ samples. The average crystallite size for NC—Al₂O₃/MgO activated at 500° C. was 2 nm or less, whereas the average crystallite size for CM—MgO was 87 nm, and for CM—Al₂O₃, 19 nm. FIG. 12 shows the XRD patterns of NC—Al₂O₃/MgO heated from 25° C. to 700° C. The conversion of the hydroxide to oxide, could not be determined from the XRD patterns.

(3) Infrared Spectroscopy. IR was used to study the aluminum oxide powder during heat activation. The heat-treated samples were ground with KBr, and pressed into pellets. IR spectra were taken after heat treatment of the pellets at 25° C., 100° C., 200° C., 300° C., 400 C. and 500° C. A gradual loss of water, and solvent was observed from 25° C. to 500° C. Therefore, when activating the Al₂O₃ at 500° C., a small amount of residual surface —OH will be present.

(4) Thermogravimetric Analysis. Particle weight loss under nitrogen flow was found to be about 40%. Similar results were observed with TGA conducted in air. The gradual weight loss observed throughout the heating was due to the hydroxide converting to oxide, and the removal of the water. The theoretical weight loss is 34%, so the observed 40% indicated that some adsorbed water was also present.

(5) Transmission Electron Microscope. TEM was also used to evaluate NC—Al₂O₃/MgO, CM—MgO and CM—Al₂O₃ samples. FIGS. 13a, b, and c show the respective TEM photographs. The CM—MgO sample consisted of single crystals having an estimated crystallite size of 10 nm (FIG. 6a). The CM—MgO samped consisted of single crystals having an estimated crystallite size of 82 nm (FIG. 13a). The NC—Al₂O₃/MgO sample (FIG. 13b) however consisted of crystallites having an average crystallite size of about 5 nm or smaller according to TEM. By compiling data from XRD, TEM, and BET it was determined that the NC-(1/1) Al₂O₃/MgO samples are made up of ≦2 nm cyrstallites.

(6) Elemental Analysis. Table 8 shows the elemental analysis results of NC-(1/1) Al₂O₃/MgO preheat-treated to 500° C. under dynamic vacuum. The data indicated the presence of some residual OH/H₂O adsorbed CO₂ was further indicated by IR. Assuming that CO₂ and surface H₂O are the only adsorbed species, a formula Al₂O₃.MgO (OH)₁₄ (CO₂)_{0.088}(H₂O)_{0 35} fits the data (oxygen by difference).

TABLE 8
Elemental anaylsis for NC-(1/1) Al₂O₃/MgO

| Element | % Calculated | % Experimental |
|---|---|---|
| Magnesium | 17% | 13.3% |
| Aluminum | 37.9% | 30.9 |
| Oxygen | 45.0% | 53.9% |
| Carbon | 0% | <0.65% |
| Hydrogen | 0% | <1.20% |

Adsorption Studies

Reaction of Al₂O₃and (1/1) Al₂O₃/MgO with CCl₄. In this example, Al₂O₃ and Al₂O₃MgO was reacted with CCl₄ to determine the destructive adsorption abilities of the metal oxides toward a model chlorocarbon at elevated adsorption temperatures.

2Al₂O₃+3CCl₄→3CO₂+2Al₂Cl₆

2MgO+CCl₄→CO₂+2MgCl₂

Based strictly on thermodynamic properties, the samples should be more reactive than the Al₂O₃ samples. However, as shown below, surface area, crystallite size, and morphology contribute to reactivity.

The above reactions were conducted via the pulse method and the products were identified by GC. The breakthrough injection, saturation injection, and molar ratios are reported in Table 9. The breakthrough injection of the reaction is the first injection that a complete destruction of CCl₄ does not occur as sensed by the detector. The saturation injection is the first injection that 100% of the injected CCl₄ is measured by the GC detector.

TABLE 9
Reaction of pulses of CCl₄ with oxide samples

| | Break- | Satu- | |
|---|---|---|---|
| Sample | through | ration | Molar Ratio |
| NC-Al₂O₃ | 57 | 98 | 1.44 mole CCl₄:1 mole Al₂O₃ |
| CM-Al₂O₃ | 2 | 17 | 1 mole CCl₄:16 mole Al₂O₃ |
| NC-(1/1) Al₂O₃/MgO | 25 | 88 | 1.8 mole CCl₄:1 mole |
| CM-MgO | 1 | 14 | 1 mole CCl₄:32 mole MgO |

Theoretical Molar Ratios:
1 mole CCl₄:2 mole MgO
1.5 mole CCl₄:1 mole Al₂O₃
2 mole CCl₄:1 mole Al₂O₃/MgO

CCl₄Adsorption. FIGS. 14-15 show graphs of the percent CCl₄ destroyed vs. the injection number. The CM—Al₂O₃ sample showed breakthrough at the second injection, and was saturated by the 17th injection. The NC—Al₂O₃ samples showed breakthrough on the 58th injection, and were saturated on the 98th injection. The CM—MgO samples showed breakthrough at the first injection, and were saturated by the 14th injection. The NC-(1/1) Al₂O₃ /MgO samples exhibited much higher saturation numbers, destroying 100% of the injected CCl₄ for the first 25 injections. The NC-(1/1) Al₂O₃ /MgO samples partially reacted with CCl₄ until the 88th injection where saturation occurred. The theoretical molar ratio of MgO:CCl₄ of the solution is 1:1.5, and (1/1) Al₂O₃/MgO:CCl₄ is 1:2. The data results showed that the NC samples were much more reactive than the CM samples. The experimental molar ratio of NC—Al₂O₃:CCl₄ at saturation sample was 1:1.44, whereas the experimental molar ratio for CM—Al₂O₃ was 16:1. The data also showed that the NC—Al₂O₃/MgO samples were much more reactive than the CM—MgO. The experimental molar ratio for NC—Al₂O₃/MgO:CCl₄ at saturation was 1:1.8, whereas the molar ratios for CM—MgO:CCl₄ samples was much higher.

Sulfur Dioxide Adsorption on Alumina, and Aluminum/Magnesium Oxide. In this example, adsorption of SO₂ was carried out to determine if the adsorption properties were different for nanocrystals compared to commercial microcrystals. These adsorption reactions were carried out on the quartz spring balance. The amount of SO₂ required for a monolayer of gas as the particle was calculated. Using 19.2 Å² as the area of an SO₂ molecule, it was determined that 5.2 molecules SO₂/nm² would form a monolayer. The data showed that at atmospheric pressure and room temperature, up to 3.5 molecules SO₂/nm² adsorbed onto NC—Al₂O₃. Similarly onto CM—Al₂O₃, 3.5 molecules SO₂/nm² adsorbed. However, 6.8 molecules SO₂/nm² adsorbed onto NC-(1/1) Al₂O₃/MgO whereas only 0.68 molecules SO₂/nm² adsorbed onto CM—MgO. See Table 10.

TABLE 10
Adsorption of SO₂ on Al₂O₃, MgO, and Al₂O₃/MgO samples
at room temperature.

| | Total | | |
|---|---|---|---|
| | Molecules | Molecules | Molecules |
| | SO₂/nm² | SO₂/nm² | SO₂/nm² |
| Sample | Adsorbed | Physisorbed | Chemisorbed |
| NC-Al₂O₃ | 3.5 | 1.8 | 1.7 |
| CM-Al₂O₃ | 3.5 | 3.0 | 0.45 |
| NC-Al₂O₃/MgO | 6.8 | 2.9 | 3.9 |
| CM-MgO | 0.68 | 0.51 | 0.17 |

The data indicate that NC—Al₂O₃/MgO efficiently adsorbed SO₂ in slightly more than one layer. After adsorption had ceased the samples were subjected to dynamic vacuum for 100 minutes to remove the physisorbed species. After this vacuum treatment, there remained 1.70 and 0.45 molecules SO₂/nm² chemisorbed onto the NC—Al₂O₃ and CM—Al₂O₃ samples respectively. The vacuum treatment removed most of the adsorbed SO₂ from the CM—MgO, whereas the NC—Al₂O₃/MgO sample retained 3.9 molecules SO₂/nm².

An in situ IR study was performed to help identify how the SO₂ was binding to the particles. FIG. 16 is a schematic of the IR cell used. Through this setup, the IR spectra of the same spot on the particle before SO₂ adsorption, with SO₂ adsorbed thereon, and after evacuation of SO₂ was obtained. The study was conducted at room temperature with 20 torr SO₂. The sample was placed on a tungsten mesh which was then placed into the cell, and the cell was then evacuated. Once optimum placement of the sample in the cell was found, background spectra were collected. The cell was pressurized with 20 torr of SO₂ for 2 hours. The cell was then evacuated, and spectra were taken over the next 2 hours. FIG. 17 shows the spectra after 2 hour evacuation for all four samples. Both CM—MgO and CM—Al₂O₃ showed no adsorbed species. Both NC—Al₂O₃ and NC—Al₂O₃/MgO showed new peaks at 1466 cm⁻¹, which corresponding to chemisorbed monodentate SO₂ adsorbed species. The data indicated that the NC samples have a high capacity for chemisorption of SO₂ (Table 10) per unit surface area indicating an intrinsically higher activity.

Destructive Adsorption of Diethyl4-Nitrophenyl Phosphate (Paraoxon). In this example, the adsorption of paraoxon was carried out to compare the rates and capacities for the metal oxide samples to dissociatively chemisorb a polar organic species, and more specifically, a toxic insecticide. By monitoring the disappearance of an UV band for paraoxon in pentane the data shown in Table 11 and FIGS. 18-19 were obtained.

TABLE 11
Destructive adsorption of Paraoxon in pentane on the oxide powders.

| Sample | Molar Ratio |
|---|---|
| NC-Al₂O₃ | 1 mole Paraoxon:11 mole Al₂O₃ |
| CM-Al₂O₃ | 1 mole Paraoxon:63 mole Al₂O₃ |
| NC-(1/1) Al₂O₃/MgO | 1 mole Paraoxon:5.6 mole Al₂O₃/MgO |
| CM-MgO | 1 mole Paraoxon:188 mole MgO |

Neither of the CM samples adsorbed much paraoxon, while the NC samples rapidly adsorbed the entire sample and developed a bright yellow color, indicating the likely formation of the p-nitrophenoxide anion on the surface.

Additional experiments with larger amounts of paraoxon were also carried out. It was found that about 5.5 μl of paraoxon (2.55E-5 moles, 1.54E19 molecules) was adsorbed by 0.0300 g NC—Al₂O₃, and about 9.5 μl of liquid paraoxon (4.40E-5 moles, 2.65E19 molecules) was adsorbed by 0.0350 g of NC—Al₂O₃/MgO. One molecule of dissociated paraoxon and with the p-nitrophenoxide group lying flat would occupy about 1 nm² of surface area. 2.4 E19 nm² surface area is available in a 0.0300 g sample of NC—Al₂O₃. It is estimated that about 0.77 monolayer of paraoxon is adsorbed. 2.8 E19 nm² surface area is available in a 0.0350 g sample of NC—Al₂O₃/MgO. It is estimated that about 1.04 monolayers are adsorbed under these conditions (room temperature, 0.01 M concentration in pentane).

After the reaction was complete the powders were filtered and IR studies were done on the materials. The data from the IR shows that the NC samples have many new species adsorbed to the powder, whereas the CM samples have little if any new species adsorbed. Table 12 gives IR spectra assignments for free paraoxon and for adsorbed paraoxon.

TABLE 12
FTIR bands for free paraoxon, and adsorbed paraoxon.

| Free Paraoxon | Assignment | Adsorbed Paraoxon | Assignment |
|---|---|---|---|
| 860 | ν C—N | 860 | ν C—N |
| 930 | CH₃ rock | 930 | CH₃ rock |
| 1045 | ν Et—O—(P) | 1045 | ν C—O—(P) |
| 1107 | CH₃ rock | 1107 | CH₃ rock |
| 1164 | CH₃ rock | 1164 | CH₃ rock |
| 1232 | ν P—O—(Ar) | | |
| 1296 | ν P═O | 1313 | ν P═O |
| 1348 | νₛ N—O | 1348 | νₛ N—O |
| 1491 | ν C—C ring | 1491 | ν C—C ring |
| 1526 | νₐₛ N—O | 1526 | |
| 1593 | ν C—C ring | 1593 | ν C—C ring |

FIG. 20 shows the IR spectra for CM—Al₂O₃, NC—Al₂O₃, CM—MgO, and NC-(1/1) Al₂O₃/MgO taken following the reaction with paraoxon. There appears to be a change in the FTIR when paraoxon is adsorbed. A band at 1296 cm⁻¹ assigned to ν P═O is broadened and shifted to approximately 1313 cm⁻¹. Also, the original peak for free paraoxon at 1232 cm⁻¹ assigned to ν P—O—Ar stretch has dissapeared. The band due to ν P—O—Et at 1045 cm⁻¹ does not change much (see Table 12), suggesting that the EtO—P moieties are not perturbed or destroyed. These data demonstrate that P═O bond is strongly perturbed through binding to Lewis acid sites on the Al₂O₃ and MgO surfaces, and that the P—OAr bond is broken.

We claim:

1. A particulate composition comprising at least two different nanocrystalline materials selected from the group consisting of the oxides and hydroxides of the elements of Groups IIA, IIIA, IVA, the transition metals and the lanthanide series of the Periodic Table, said different materials being solidified and intimately intermingled on a molecular level, with at least one of the materials exhibiting an average crystallite size of from about zero up to about 4 nm by XRD analysis.

2. The composition of claim 1, including from 2-4 of said different materials.

3. The composition of claim 2, including 2 of said different materials.

4. The composition of claim 1, all of said different materials exhibiting an average crystallite size of from about zero to about 4 nm by XRD analysis.

5. The composition of claim 1, including aluminum oxide and magnesium oxide as said different materials.

6. The composition of claim 1, said composition having a BET surface area which is at least about 30% larger than the surface area of at least one of the nanocrystalline materials making up the composition, if said at least one nanocrystalline solid were prepared alone.

7. The composition of claim 6, said composition having a BET surface area which is at least about 50% larger than the surface area of at least one of the nanocrystalline materials making up the composition, if said at least one nanocrystalline solid were prepared alone.

8. The composition of claim 1, said different materials selected from the group consisting of the oxides and hydroxides of Al, Mg, Ca, Sr, Ba, Zn, Co, Ni, Fe, Ti, Pd, Rh, V, Mn, Ga and Si.

9. The composition of claim 1, there being two of said different materials selected from the group consisting of the combinations, Al₂O₃.MgO, Al₂O₃.CaO, Al₂O₃.SrO, Al₂O₃.BaO, Al₂O₃.ZnO, Al₂O₃.CoO, Al₂O₃.NiO, Al₂O₃.Fe₂O₃, Al₂O₃.MgO. TiO₂, Al₂O₃.PdO, Al₂O₃.RhO, Al₂O₃.V₂O₃Al₂O₃.MnO, Ga₂O₃.MgO, and SiO₂.MgO.

10. The composition of claim 1, one of said materials being present in a greater amount by weight as compared with another of said materials.

11. The composition of claim 1, said composition being made up of first and second different nanocrystalline materials, with a molar ratio of the first and second materials ranging from about 0.1-10.

12. A particulate composition comprising at least two different nanocrystalline materials selected from the group consisting of the oxides and hydroxides of the elements of Groups IIA, IIIA, IVA, the transition metals and the lanthanide series of the Periodic Table, said different materials being solidified and intimately intermingled on a molecular level, said composition having a BET surface area which is at least about 30% larger than the surface area of at least one of the nanocrystalline materials making up the composition, if said at least one nanocrystalline materials were prepared alone.

13. The composition of claim 12, including from 2-4 of said different materials.

14. The composition of claim 13, including 2 of said different materials.

15. The composition of claim 12, all of said different materials exhibiting a crystallite size of about zero to about 4 nm by XRD analysis.

16. The composition of claim 12, including aluminum oxide and magnesium oxide as said different materials.

17. The composition of claim 12, said composition having a BET surface area which is at least about 50% larger than the surface area of at least one of the nanocrystalline materials making up the composition, if said at least one nanocrystalline solid were prepared alone.

18. The composition of claim 12, said different materials selected from the group consisting of the oxides and hydroxides of Al, Mg, Ca, Sr, Ba, Zn, Co, Ni, Fe, Ti, Pd, Rh, V, Mn, Ga and Si.

19. The composition of claim 12, there being two of said different materials selected from the group consisting of the combinations, Al₂O₃.MgO, Al₂O₃.CaO, Al₂O₃.SrO, Al₂O₃.BaO, Al₂O_{.ZnO, Al}₂O₃.CoO, Al₂O₃.NiO, Al₂O₃.Fe₂O₃, Al₂O₃.MgO.TiO₂, Al₂O₃.PdO, Al₂O₃.RhO, Al₂O₃.V₂0₃, Al₂O₃.MnO, Ga₂O₃.MgO, and SiO₂.Mgo.

20. The composition of claim 12, one of said materials being present in a greater amount by weight as compared with another of said materials.

21. The composition of claim 12, said composition being made up of first and second different nanocrystalline materials, with a molar ratio of the first and second materials ranging from about 0.1-10.

22. A gel comprising a mixture of at least two different hydroxides of the elements of Groups IIA, IIIA, IVA, the transition metals and the lanthanide series of the Periodic Table.

23. The gel of claim 22, including from about 2-4 of said different hydroxides.

24. The gel of claim 23, including two of said different hydroxides.

25. The gel of claim 22, including aluminum hydroxide and magnesium hydroxide as said different hydroxides.

26. The gel of claim 22, said different hydroxides selected from the group consisting of the hydroxides of Al, Mg, Ca, Sr, Ba, Zn, Co, Ni, Fe, Ti, Pd, Rh, V, Mn, Ga and Si.

27. The gel of claim 22, one of said hydroxides being present in a greater amount by weight as compared with another of said hydroxides.

28. The gel of claim 22, said composition being made up of first and second different hydroxides, with a molar ratio of the first and second hydroxides ranging from about 0.10-10.

29. The gel of claim 22, said gel including a quantity of water.

30. A solid composition comprising a mixture of at least two different solid hydroxides of the elements of Groups IIA, IIIA, IVA, the transition metals and the lanthanide series of the Periodic Table.

31. The composition of claim 30, including from about 2-4 of said different solid hydroxides.

32. The composition of claim 31, including two of said different solid hydroxides.

33. The composition of claim 30, including solid aluminum hydroxide and soid magnesium hydroxide as said different solid hydroxides.

34. The composition of claim 30, said different solid hydroxides selected from the group consisting of the solid hydroxides of Al, Mg, Ca, Sr, Ba, Zn, Co, Ni, Fe, Ti, Pd, Rh, V, Mn, Ga and Si.

35. The composition of claim 30, one of said solid hydroxides being present in a greater amount by weight as compared with another of said solid hydroxides.

36. The composition of claim 30, said composition being made up of first and second different solid hydroxides, with a molar ratio of the first and second solid hydroxides ranging from about 0.10-10.

37. A solid, particulate, nanocrystalline composition prepared by the thermal conversion of the hydroxide composition of claim 30 to the corresponding oxides.

38. A method of preparing a particulate nanocrystalline composition comprising the steps of:
separately preparing a plurality of different alkoxide solutions in a compatible solvent, each alkoxide including an ion moiety selected from the group consisting of the ions of the elements of Groups IIA, IIIA, IVA, the transition metals and the lanthanide series of the Periodic Table;
mixing and hydrolyzing said plurality of alkoxide solutions to give a gel comprising the corresponding hydroxides of said different alkoxides; and
drying said gel to yield a solid hydroxide composition or thermally converting said hydroxides to the corresponding solid oxides.

39. The method of claim 38, there being from 2-4 of said different alkoxide solutions.

40. The method of claim 38, there being 2 of said different alkoxide solutions.

41. The method of claim 40, including aluminum alkoxide solution and magnesium alkoxide solution as said different alkoxide solutions.

42. The method of claim 38, each of said different alkoxide solutions selected from the group consisting of the alkoxides including an ion moiety of Al, Mg, Ca, Sr, Ba, Zn, Co, Ni, Fe, Ti, Pd, Rh, V, Mn, Ga and Si.

43. The method of claim 38, each of said different alkoxides has the formula [R—O]ₙ—X_{q}, where R is a C1—C6 straight or branched chain alkyl group, X is said ion moiety, and n and q are selected so as to balance the valence of the alkoxide.

44. The method of claim 43, where R is a tert-butyl group.

45. Solid oxides produced by the method of claim 38.

46. A method comprising the steps of contacting a target material with a composition according to claim 1, and causing adsorption reaction to occur between the target material and said composition.

47. The method of claim 46, said target material selected from the group consisting of compounds selected from the group of acids, alcohols, aldehydes, compounds containing an atom of P, S, N, Se, or Te, hydrocarbon compounds, toxic metal compounds, halogenated compounds, bacteria, fungi, viruses, rickettsiae, chlamydia, and toxins.

48. The method of claim 46, said contacting step comprising the step of contacting a fluid containing said target material with a quantity of said composition.

49. The method of claim 46, said contacting step comprising the step of distributing a quantity of said composition onto an area where said target material is present.

50. The method of claim 46, said contacting step being carried out at a temperature on from about −70-800° C.

51. The method of claim 50, said temperature being from about −25-100° C.

52. A method of adsorbing a target compound comprising the step of contacting the target compound with composition according to claim 12.

53. The method of claim 52, said target material selected from the group consisting of compounds selected from the group of acids, alcohols, aldehydes, compounds containing an atom of P, S, N, Se, or Te, hydrocarbon compounds, toxic metal compounds, halogenated compounds, bacteria, fungi, viruses, rickettsiae, chlamydia, and toxins.

54. The method of claim 52, said contacting step comprising the step of contacting a fluid containing said target material with a quantity of said composition.

55. The method of claim 52, said contacting step comprising the step of distributing a quantity of said composition onto an area where said target material is present.

56. The method of claim 52, said contacting step being carried out at a temperature of from about −70-800° C.

57. The method of claim 56, said temperature being from about −25-100° C.

58. Nanocrystalline aluminum oxide having an average BET surface area of at least about 700 m²/g.

59. The aluminum oxide of claim 58, said surface area being from about 725-850 m²/g.

60. The aluminum oxide of claim 58, said aluminum oxide exhibiting an amorphous pattern by XRD analysis.

61. A method of adsorbing a target compound comprising the step of contacting the target compound with aluminum oxide according to claim 60.

62. The method of claim 61, said target material selected from the group consisting of compounds selected from the group of acids, alcohols, aldehydes, compounds containing an atom of P, S, N, Se, or Te, hydrocarbon compounds, toxic metal compounds, halogenated compounds, bacteria, fungi, viruses, rickettsiae, chlamydia, and toxins.

63. The method of claim 61, said contacting step comprising the step of contacting a fluid containing said target material with a quantity of said aluminum oxide.

64. The method of claim 61, said contacting step comprising the step of distributing a quantity of saidaluminum oxide onto an area where said target material is present.

65. The method of claim 61, said contacting step being carried out at a temperature of from about −70-800° C.

66. The method of claim 65, said temperature being from about −25-100° C.
